(19) United States
(12) Patent Application Publication
(10) Pub. No.: US 2025/0361731 A1
(43) Pub. Date: Nov. 27, 2025

(54) SCAFFOLD OR SAFETY DECKING LEG ADAPTER

(71) Applicant: J. MAC SAFETY SYSTEMS LIMITED, Stockton-on-Tees (GB)

(72) Inventor: Luis MCCARTHY, Stockton-on-Tees (GB)

(21) Appl. No.: 19/108,353

(22) PCT Filed: Feb. 2, 2023
(86) PCT No.: PCT/GB2023/050229

§ 371 Date: Mar. 3, 2025

(30) Foreign Application Priority Data
Feb. 3, 2022 (GB) 2201380.9

(51) Int. Cl. E04G 7/20; E04G 7/00; F16B 7/00

(52) U.S. Cl. CPC E04G 7/20; F16B 7/00; E04G 2007/005

(57) ABSTRACT

A scaffold or safety decking leg adapter comprising a first shaped adapter part at a first end and with a first exterior dimension; a second shaped adapter part at a second end opposite to the first end and with a second exterior dimension different to the first exterior dimension; a first bore portion through the first shaped adapter part and with a first interior dimension; a second bore portion through the second shaped adapter part, in communication with the first bore portion and with a second interior dimension different to the first interior dimension; and an abutment shoulder between the first bore portion and the second bore portion.

### TECHNICAL FIELD OF THE INVENTION

The present invention relates generally to the field of scaffold or safety decking and more particularly to a scaffold or safety decking leg adapter to allow use of different vertical members or legs with the same head.

### BACKGROUND TO THE INVENTION

Many scaffold manufacturers and safety deck manufacturers make proprietary scaffold and safety deck systems and components, with the components of one proprietary system being differently configured, usually in terms of size and/or shape to the components of other proprietary systems.

The reason for this is typically commercial, to maximise value to the manufacturer as only components designed and manufactured by that manufacturer can be used with other components designed and manufactured by that manufacturer.

However, this specificity means that a user becomes increasingly dependent on one manufacturer and in effect, becomes ‘locked in’ to using components from only one manufacturer. The more components a user has from a particular manufacturer, the more that user will need to purchase new and/or replacement components from the same manufacturer to match that the components already owned.

This is undesirable to users.

### SUMMARY OF THE INVENTION

According to one aspect there is provided a scaffold or safety decking leg adapter comprising
a) A first shaped adapter part at a first end and with a first exterior dimension;
b) A second shaped adapter part at a second end opposite to the first end and with a second exterior dimension different to the first exterior dimension;
c) A first bore portion through the first shaped adapter part and with a first interior dimension;
d) A second bore portion through the second shaped adapter part, in communication with the first bore portion and with a second interior dimension different to the first interior dimension; and
e) An abutment shoulder between the first bore portion and the second bore portion.

Providing a scaffold or safety decking leg adapter with these features enables the use of the adapter with:
1. a Scaffolding tube (in its use as a vertical standard diameter 48.3 mm), allowing a base and head to be fitted on top to connect to the safety decking system;
2. a System Scaffolding standard with Spigot (in its use as a vertical standard diameter 48.3 mm, spigot diameter 36 mm), allowing a base and head to be fitted on top to connect to the safety decking system; and
3. a scaffolding base jack to sit on top of the base jack allowing a safety decking leg profile to be fitted on top. A base jack may allow the height of the system to be increased by up to 500 mm, offering flexibility in heights required.

For ease of reference, the first exterior dimension will preferably be smaller than the second exterior dimension.

The adapter may be manufactured in multiple parts or pieces but preferably, will have a single piece construction. The adapter or parts therefor may be formed using a moulding process although any method of manufacturing suitable for the material(s) could be used.

One or more plastic or polymeric materials is the preferred choice for construction of the adapter although any robust and strong material such as a metal, metal alloy, or composite material may be used. A PVC or fibre filled PVC is particularly preferred.

The adapter will normally be used in a vertical orientation. The adapter will normally be mounted relative to an end of a vertical member in a scaffold or safety deck support system. The adapter may be used with the first shaped adapter part uppermost or inverted with the second shaped adapter part uppermost depending on the vertical member in a scaffold or safety deck support system with which the adapter is to engage.

Any part of the first shaped adapter part and/or second shaped adapter part may abut, receive and/or be received by a vertical member in a scaffold or safety deck support system with which the adapter is to engage.

The adapter may include a first shaped adapter part at a first end and with a first exterior dimension. As mentioned above, the first shaped adapter part may preferably have a first exterior dimension which is smaller (the smaller end) than the second exterior dimension of the second shaped adapter part (the larger end).

The first shaped adapter part may have a rectangular outer shape. More preferably, the first shaped adapter part may have a square outer shape.

The first shaped adapter part may have a circular inner first bore portion extending into the first shaped adapter part. The first bore portion will preferably extend longitudinally into the first shaped adapter part.

The outer shape of the first shaped adapter part may be formed by respective external surfaces of a plurality of ribs. In the rectangular or square outer shapes, a number of ribs may be provided to form each side of the first shaped adapter part.

The ribs may extend outwardly from a wall of the first shaped adapter part. The ribs may be or include a tapering portion. The tapering portion may extend outwardly away from a central longitudinal axis of the first shaped adapter part as the ribs extend towards the second shaped adapter part. In one embodiment, the ribs will taper outwardly from a free end of the first shaped adapter part to approximately the middle of the adapter. A tapered end part may be provided adjacent to the free end of the adapter on each rib, and with a steeper angle than the remainder of the rib, to ease entry of the first shaped adapter part into a hollow member.

The respective external sides/surfaces of the ribs may define the exterior shape and dimension of the first shaped adapter part. The external sides/surfaces of the ribs may be coplanar on each side of the first shaped adapter part.

The outer shape of the first shaped adapter part may be received within a hollow end of a scaffold or safety deck support member. Provision of the preferred tapering ribs allows the first shaped adapter part to be received within hollow members of different internal dimensions.

The ribs may be formed on/extend from an outer cylindrical surface of an annular wall, an inner surface of which defines the first bore portion.

The adapter may include a second shaped adapter part at a second end opposite to the first end and with a second exterior dimension different to the first exterior dimension. As mentioned above the second shaped adapter part may be larger in exterior dimension than the first shaped adapter part.

The second shaped adapter part may have a rectangular outer shape. More preferably, the second shaped adapter part may have a square outer shape.

The second shaped adapter part may have a circular inner second bore portion extending into the second shaped adapter part. The second bore portion will preferably extend longitudinally into the second shaped adapter part.

The outer shape of the second shaped adapter part may be formed by respective external surfaces of a plurality of ribs. In the rectangular or square outer shapes, a number of ribs may be provided to form each side of the second shaped adapter part.

The ribs may extend outwardly from a wall of the second shaped adapter part. The ribs may be or include a tapering portion. The tapering portion may extend outwardly away from a central longitudinal axis of the second shaped adapter part as the ribs extend towards the first shaped adapter part. In one embodiment, the ribs will taper outwardly from a free end of the second shaped adapter part to approximately the middle of the adapter. A tapered end part may be provided adjacent to the free end of the adapter on each rib, and with a steeper angle than the remainder of the rib, to ease entry of the second shaped adapter part into a hollow member.

The respective external sides/surfaces of the ribs may define the exterior shape and dimension of the second shaped adapter part. The external sides/surfaces of the ribs may be coplanar on each side of the second shaped adapter part.

The outer shape of the second shaped adapter part may be received within a hollow end of a scaffold or safety deck support member. Provision of the preferred tapering ribs allows the second shaped adapter part to be received within hollow members of different internal dimensions.

The ribs may be formed on/extend from an outer surface of a rectangular wall. The rectangular wall may define a hollow volume within it.

An annular wall or upstand may be provided within the hollow volume. The annular wall or upstand may be centered within the hollow volume. The annular wall or upstand will preferably be hollow. The annular wall or upstand will preferably be elongate, extending substantially over the length of the second shaped adapter part. The annular wall or upstand will preferably extend further from the first end of the adapter than the free or end edge of the rectangular wall

An inner surface of the annular wall or upstand may preferably define the second bore portion.

An outer surface of the annular wall or upstand may preferably be spaced from an inner surface of the rectangular wall.

One or more centering ribs may extend between the inner surface of the rectangular wall and the outer surface of the annular wall or upstand. A free end of each of the centering ribs may be spaced from the free ends of the annular wall or upstand and the rectangular wall.

An exterior surface of the elongate ribs on the second shaped adapter part may extend out further than the exterior surface of the elongate ribs on the first shaped adapter part making the exterior dimensions of the preferably rectangular second shaped adapter part larger than the exterior dimensions of the preferably rectangular first shaped adapter part. The second shaped adapter part is preferably larger in both rectangular dimensions that the first shaped adapter part.

The adapter may include a first bore portion through the first shaped adapter part and with a first interior dimension.

The first bore portion is preferably circular in cross-sectional shape. The first bore portion may be elongate. The first bore portion may extend from a free end toward the second shaped adapter part, to approximately a centre of the adapter.

An internal surface of the first bore portion may be provided with a number of ribs extending longitudinally over the internal surface and radially inwardly. The ribs may increase in height as the rib extends toward the second shaped adapter part.

A tapered end part may be provided adjacent to the free first end of the adapter on each rib, and with a steeper angle than the remainder of the rib, to ease entry of a member into the first bore portion.

The respective internal sides/surfaces of the ribs may define the interior shape and dimension of the first bore portion.

The first bore portion may have a larger internal diameter than the second bore portion.

The first bore portion is preferably coaxial with the second bore portion.

The adapter may include a second bore portion through the second shaped adapter part, in communication with the first bore portion and with a second interior dimension different to the first interior dimension.

The second bore portion is preferably circular in cross-sectional shape. The second bore portion may be elongate. The second bore portion may extend from a free end toward the first shaped adapter part, to approximately a centre of the adapter.

An internal surface of the second bore portion may be provided with a number of ribs extending longitudinally over the internal surface and radially inwardly. The ribs may increase in height as the rib extends toward the first shaped adapter part.

A tapered end part may be provided adjacent to the free second end of the adapter on each rib, and with a steeper angle than the remainder of the rib, to ease entry of a member into the second bore portion.

The respective internal sides/surfaces of the ribs may define the interior shape and dimension of the second bore portion.

The second bore portion is preferably smaller than the first bore portion.

The adapter may include an abutment shoulder between the first bore portion and the second bore portion. The abutment shoulder may extend between the inner surface of the first bore portion and the inner surface of the second bore portion.

The abutment shoulder may be perpendicular to both the inner surface of the first bore portion and the inner surface of the second bore portion. The abutment shoulder may be planar.

A lateral flange may be provided from the adapter. The lateral flange may extend radially outwardly from the first shaped adapter part and/or the second shaped adapter part. The lateral flange may be planar. The lateral flange may be substantially rectangular in outer shape. The lateral flange may extend perpendicularly to the first shaped adapter part and the second shaped adapter part. The lateral flange may have two parallel surfaces, one of the parallel surfaces facing each of the first shaped adapter part and the second shaped adapter part, and an outer, linking edge.

The lateral flange may be located between the first shaped adapter part and the second shaped adapter part. One of the two parallel surfaces may define the end of the first shaped adapter part and the other of the two parallel surfaces may define the end of the second shaped adapter part.

One of the parallel surfaces may be coplanar with the lateral shoulder.

At least one of the parallel surfaces may include one or more shaped depressions formed thereinto.

The adapter may be associated with a shock absorbing member. The shock absorbing member may be manufactured in a single piece. The shock absorbing member will preferably be resilient and/or deformable.

The shock absorbing member may be any shape but will preferably have a portion to correspond with shape of the outer end of the annular wall or upstand of the second shaper adapter part. The shock absorbing member will preferably be circular.

The shock absorbing member may have a substantially circular main wall and a side wall perpendicularly depending from an outer edge of the main wall.

An annular or circular formation may be provided on an underside of the main wall to form an annular depression into the underside of the main wall. The annular depression will preferably seat the end edge of the annular wall or upstand of the second shaper adapter part.

The outer surface of the main wall may be provided with one or more shaped protrusions. The protrusions may have any shape. The protrusions will preferably function to cushion of absorb shock or spread load or shock.

Each protrusion may be pointed or angled at an outer end and be wider towards a base thereof. Each protrusion may be at least partially conical or frustoconical.

The protrusions may be organised into groups. An outer ring of smaller protrusions with a smaller footprint or base area may be provided outside an inner ring of larger protrusions with a larger footprint or base area.

One or more openings may be provided through the walls of the first shaped adapter part and/or the second shaped adapted part to receive a locking pin therethrough.

### DETAILED DESCRIPTION OF THE INVENTION

In order that the invention may be more clearly understood one or more embodiments thereof will now be described, by way of example only, with reference to the accompanying drawings, of which:

FIG. 1 is an isometric view from a first end of a safety decking leg adapter of an embodiment.

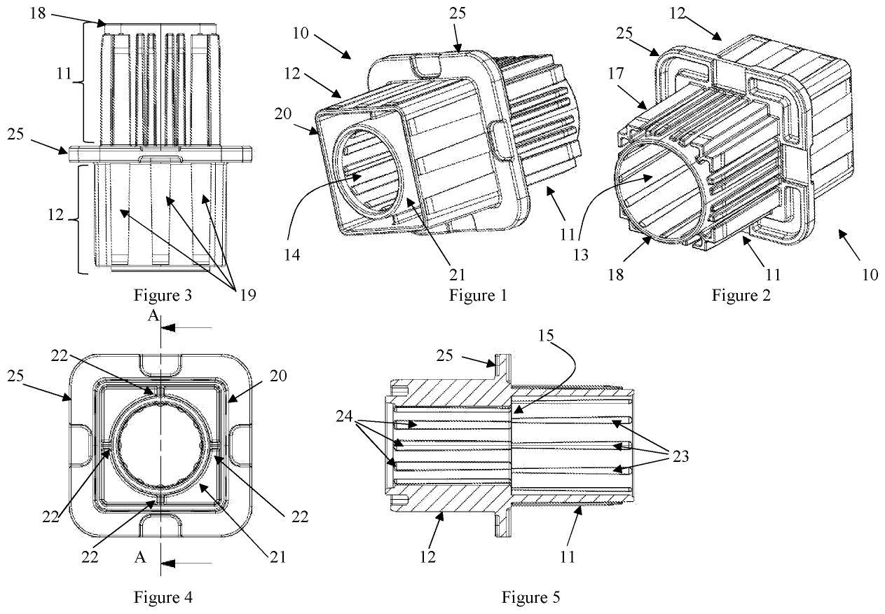

FIG. 2 is an isometric view from a second end of the safety decking leg adapter illustrated in FIG. 1.

FIG. 3 is a side elevation view of the safety decking leg adapter illustrated in FIG. 1.

FIG. 4 is a view from below of the safety decking leg adapter illustrated in FIG. 1.

FIG. 5 is a section view of the safety decking leg adapter illustrated in FIG. 4 along line A-A.

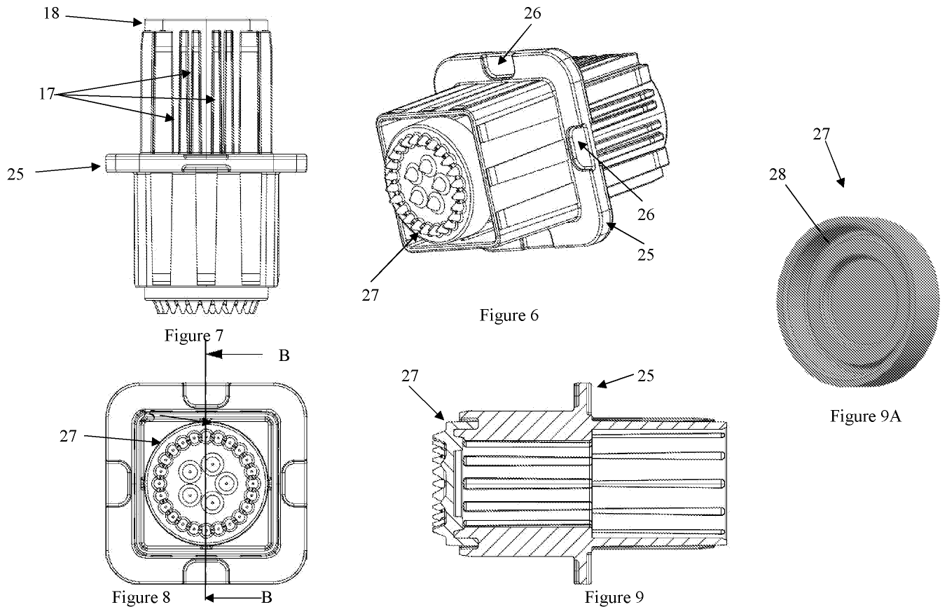

FIG. 6 is an isometric view from a first end of the safety decking leg adapter illustrated in FIG. 1 with a shock absorbing insert.

FIG. 7 is a side elevation view of the safety decking leg adapter illustrated in FIG. 6.

FIG. 8 is a view from below of the safety decking leg adapter illustrated in FIG. 6.

FIG. 9 is a section view of the safety decking leg adapter illustrated in FIG. 8 along line B-B.

FIG. 9A is an underside view of the shock absorbing member of an embodiment.

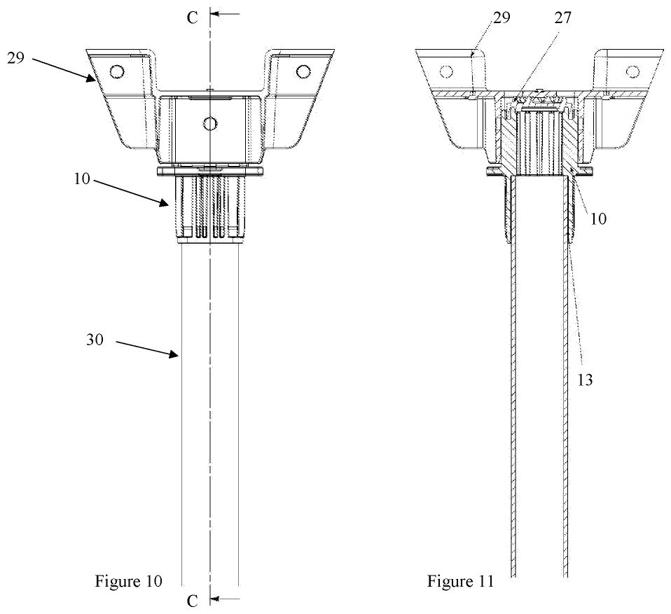

FIG. 10 is a side elevation view of a system scaffold leg and head with a leg adapter illustrated in FIG. 6 with a shock absorbing insert.

FIG. 11 is a sectional side view of the arrangement illustrated in FIG. 10 along line C-C.

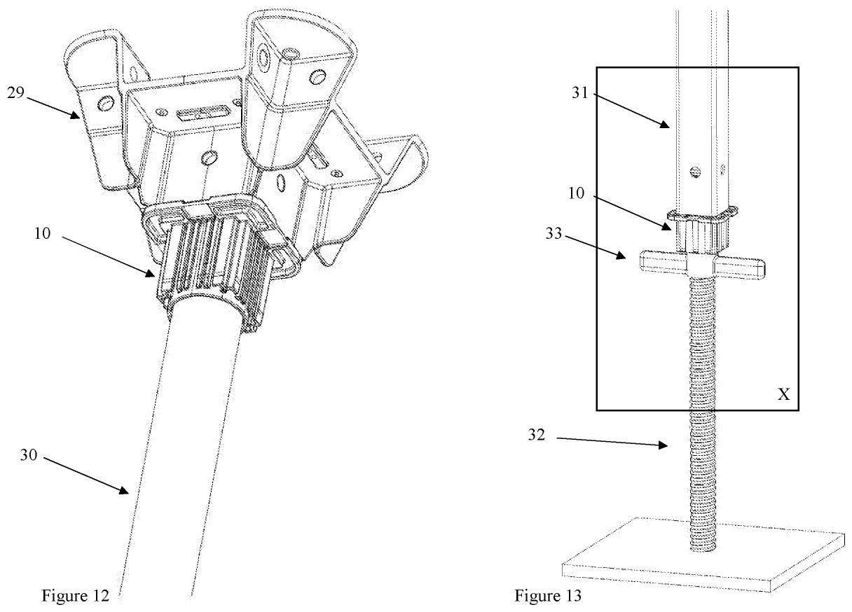

FIG. 12 is an isometric view of the configuration illustrated in FIG. 10.

FIG. 13 is an isometric view of an adjustable screw jack and a standard leg with a safety decking leg adapter of an embodiment.

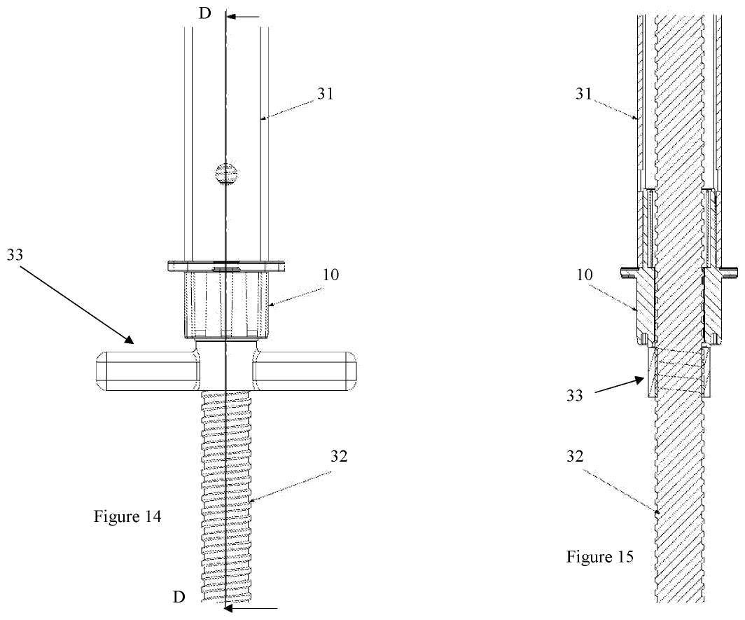

FIG. 14 is a side elevation view of portion of the arrangement illustrated in FIG. 13 and identified as ‘X’.

FIG. 15 is a sectional side view of the arrangement illustrated in FIG. 14 along line D-D.

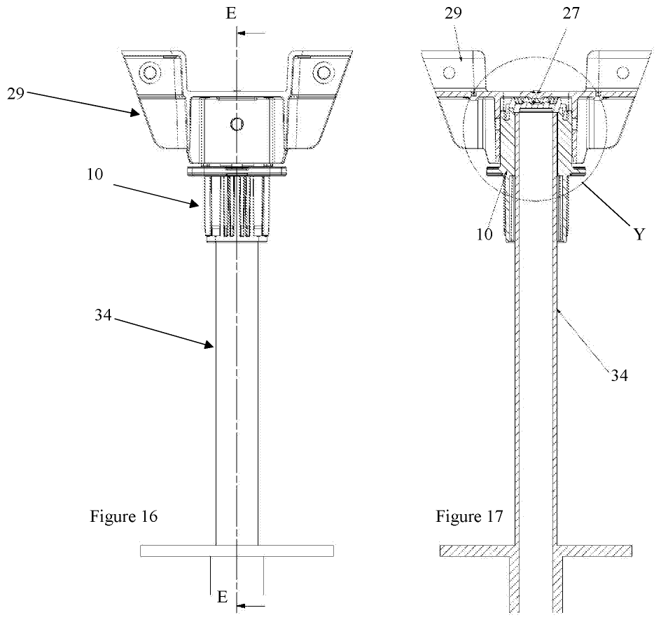

FIG. 16 is a side elevation view of a 48 mm scaffold leg and head with a leg adapter as illustrated in FIG. 6 with a shock absorbing insert.

FIG. 17 is a sectional side view of the arrangement illustrated in FIG. 16 along line E-E.

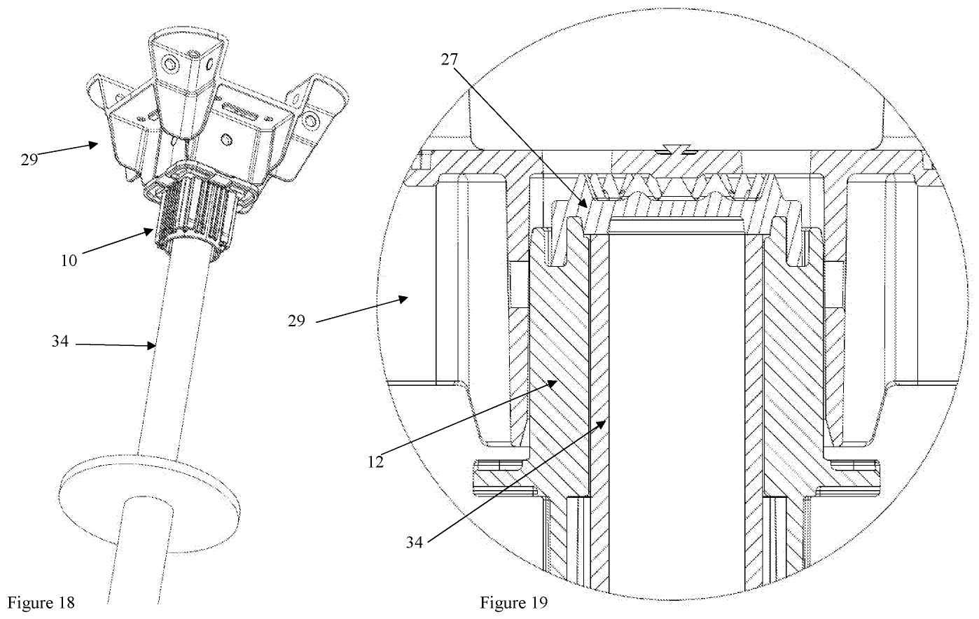

FIG. 18 is an isometric view of the configuration illustrated in FIG. 16.

FIG. 19 is a detailed view of the portion identified as ‘Y’ from FIG. 17.

The scaffold or safety decking leg adapter 10 illustrated in the Figures comprises a first shaped adapter part 11 at a first end and with a first exterior dimension and a second shaped adapter part 12 at a second end opposite to the first end and with a second exterior dimension different to the first exterior dimension. The scaffold or safety decking leg adapter 10 also includes a first bore portion 13 through the first shaped adapter part 11 and with a first interior dimension and second bore portion 14 through the second shaped adapter part 12, in communication with the first bore portion 13 and with a second interior dimension different to the first interior dimension. An abutment shoulder 15 is provided between the first bore portion 13 and the second bore portion 14.

For ease of reference, the first exterior dimension will preferably be smaller than the second exterior dimension.

The adapter may be manufactured in multiple parts or pieces but preferably, will have a single piece construction. The adapter or parts therefor may be formed using a moulding process although any method of manufacturing suitable for the material(s) could be used.

The adapter 10 will normally be used in a vertical orientation as shown in FIGS. 10 to 19. The adapter 10 will normally be mounted relative to an end of a vertical member in a scaffold or safety deck support system. The adapter 10 may be used with the first shaped adapter part 11 uppermost (as shown in FIGS. 13 to 15 for example) or inverted with the second shaped adapter part 12 uppermost (as shown in FIGS. 10 to 12 and 16 to 19) depending on the vertical member in a scaffold or safety deck support system with which the adapter is to engage.

Any part of the first shaped adapter part 11 and/or second shaped adapter part 12 may abut, receive and/or be received by a vertical member in a scaffold or safety deck support system with which the adapter 10 is to engage.

The first shaped adapter part 11 illustrated has a square outer shape. The first shaped adapter part 11 of the illustrated embodiment has a first exterior dimension (the length of the sidewall) which is smaller (the smaller end) than the second exterior dimension of the second shaped adapter part 12 (the larger end). The perimeter measurement of the square first shaped adapter part 11 illustrated is smaller than the perimeter measurement of the square second shaped adapter part 12.

As shown, the first shaped adapter part 11 has a circular inner first bore portion 13 extending into the first shaped adapter part 11. The first bore portion 13 extends longitudinally into the first shaped adapter part 11.

The square outer shape of the first shaped adapter part 11 is formed by respective external surfaces of a plurality of ribs 17, best illustrated in FIG. 2. In the square outer shape shown, a number of ribs 17 of different configurations are provided to form each side of the first shaped adapter part 11.

The ribs 17 formed on/extend outwardly from an outer cylindrical surface of an annular wall 18 of the first shaped adapter part 11, and the inner surface of the annular wall 18 forms the first bore portion 13.

The ribs 17 may include a tapering portion. The tapering portion may extend outwardly away from a central longitudinal axis of the first shaped adapter part 11 as the ribs 17 extend towards the second shaped adapter part 12. In one embodiment, the ribs 17 will taper outwardly from a free end of the first shaped adapter part 11 to approximately the middle of the adapter 10. Provision of the preferred tapering ribs allows the first shaped adapter part to be received within hollow members of different internal dimensions.

As illustrated in FIG. 2, a tapered end part may be provided adjacent to the free end of the adapter 10 on each rib 17, and with a steeper angle than the remainder of the rib 17, to ease entry of the first shaped adapter part 11 into a hollow member, such as that shown in FIGS. 13 to 15.

The respective external sides/surfaces of the ribs 17 may define the exterior shape and dimension of the first shaped adapter part 11 as shown. The external sides/surfaces of the ribs 17 will preferably be coplanar on each side of the first shaped adapter part 11.

The second shaped adapter part 12 of the illustrated adapter 10 also has a square outer shape. The second shaped adapter part 12 has a circular inner second bore portion 14 extending into the second shaped adapter part 12. The second bore portion 14 will preferably extend longitudinally into the second shaped adapter part 12.

The outer shape of the second shaped adapter part 12 may also be formed by respective external surfaces of a plurality of ribs 19. In the illustrated square outer shape, a number of ribs 19 may be provided to form each side of the second shaped adapter part 12.

As with the ribs 17 on the first shaped adapter part 11, the ribs 19 may extend outwardly from a wall of the second shaped adapter part 12, but in this case, the wall may be rectangular.

The ribs 19 may include a tapering portion. The tapering portion may extend outwardly away from a central longitudinal axis of the second shaped adapter part 12 as the ribs 19 extend towards the first shaped adapter part 11. In one embodiment, the ribs 19 will taper outwardly from a free end of the second shaped adapter part 12 to approximately the middle of the adapter 10. A tapered end part may be provided adjacent to the free end of the adapter on each rib 19, and with a steeper angle than the remainder of the rib 19, to ease entry of the second shaped adapter part 12 into a hollow member. Provision of the preferred tapering ribs 19 allows the second shaped adapter part 12 to be received within hollow members of different internal dimensions.

The respective external sides/surfaces of the ribs 19 may define the exterior shape and dimension of the second shaped adapter part. The external sides/surfaces of the ribs 19 may be coplanar on each side of the second shaped adapter part 12.

As shown in FIG. 1 in particular, the rectangular wall 20 may define a hollow volume within it. An annular wall or upstand 21 is provided, centered within the hollow volume. The annular wall or upstand is hollow and elongate, extending substantially over the length of the second shaped adapter part 12. The annular wall or upstand 21 will preferably extend further from the first end of the adapter 10 than the free or end edge of the rectangular wall 20, as shown in FIG. 3. An inner surface of the annular wall or upstand 21 defines the second bore portion 14.

In the embodiment shown in FIG. 1, an outer surface of the annular wall or upstand 21 is spaced from an inner surface of the rectangular wall 20.

Four centering ribs 22 are provided in the illustrated adapter 10, extending between the inner surface of the rectangular wall 20 and the outer surface of the annular wall or upstand 21. A free end of each of the centering ribs 22 is spaced from the free ends of the annular wall or upstand 21 and the rectangular wall 20.

An exterior surface of the elongate ribs 19 on the second shaped adapter part 12 extend out further than the exterior surface of the elongate ribs 17 on the first shaped adapter part 11 making the exterior dimensions of the rectangular second shaped adapter part 12 larger than the exterior dimensions of the rectangular first shaped adapter part 11. The second shaped adapter part 12 is preferably larger in both rectangular dimensions that the first shaped adapter part 11.

In the illustrated embodiment, an internal surface of the first bore portion 13 is provided with a number of ribs 23 extending longitudinally over the internal surface and radially inwardly. The ribs 23 may increase in height as the rib 23 extends toward the second shaped adapter part 12.

A tapered end part may be provided adjacent to the free first end of the adapter 10 on each rib 23, and with a steeper angle than the remainder of the rib 23, to ease entry of a member into the first bore portion 13.

The respective internal sides/surfaces of the ribs 23 may define the interior shape and dimension of the first bore portion 13.

The first bore portion 13 may have a larger internal diameter than the second bore portion 14 as shown in FIG. 5.

The first bore portion 13 is preferably coaxial with the second bore portion 14.

An internal surface of the second bore portion 14 may also be provided with a number of ribs 24 extending longitudinally over the internal surface and radially inwardly. The ribs 24 may increase in height as the rib 24 extends toward the first shaped adapter part 11.

A tapered end part may be provided adjacent to the free second end of the adapter on each rib 24, and with a steeper angle than the remainder of the rib 24, to ease entry of a member into the second bore portion 14.

The respective internal sides/surfaces of the ribs 24 may define the interior shape and dimension of the second bore portion 14.

The abutment shoulder 15 extends between the inner surface of the first bore portion 13 and the inner surface of the second bore portion 14.

In the illustrated form, the abutment shoulder 15 is perpendicular to both the inner surface of the first bore portion 13 and the inner surface of the second bore portion 14. The abutment shoulder 15 is planar.

A lateral flange 25 may be provided on the adapter 10. The lateral flange 25 extends radially outwardly from the first shaped adapter part 11 and/or the second shaped adapter part 12. The lateral flange shown, is planar.

The lateral flange 25 shown in the illustrated embodiment is substantially rectangular in outer shape. The lateral flange 25 may extend perpendicularly to the first shaped adapter part 11 and the second shaped adapter part 12. The lateral flange 25 has two parallel surfaces, one of the parallel surfaces facing each of the first shaped adapter 11 part and the second shaped adapter part 12, and an outer, linking edge.

The lateral flange 25 is located between the first shaped adapter part 11 and the second shaped adapter part 12. One of the two parallel surfaces may define the end of the first shaped adapter part 11 and the other of the two parallel surfaces may define the end of the second shaped adapter part 12.

One of the parallel surfaces may be coplanar with the lateral shoulder 15.

The parallel surfaces may include one or more shaped depressions 26 formed thereinto as shown in FIGS. 1 to 9.

The adapter 10 may be associated with a shock absorbing member 27 as shown in FIGS. 6 to 9. The shock absorbing member 27 may be manufactured in a single piece. The shock absorbing member will preferably be resilient and/or deformable.

The shock absorbing member 27 may be any shape but will preferably have a portion to correspond with shape of the outer end of the annular wall or upstand 21 of the second shaper adapter part 12. The shock absorbing member of an embodiment is circular as illustrated in FIGS. 6 to 9A.

The shock absorbing member 27 may have a substantially circular main wall and a side wall perpendicularly depending from an outer edge of the main wall.

An annular or circular formation may be provided on an underside of the main wall to form an annular depression 28 into the underside of the main wall. The annular depression 28 will preferably seat the end edge of the annular wall or upstand 21 of the second shaper adapter part 12.

The outer surface of the main wall may be provided with one or more shaped protrusions as shown in FIGS. 6 to 9. The protrusions may have any shape. The protrusions will preferably function to cushion of absorb shock or spread load or shock.

As shown, each protrusion is pointed or angled at an outer end and be wider towards a base thereof. The protrusions of the illustrated embodiment are organised into two groups with an outer ring of smaller protrusions, with a smaller footprint or base area, provided outside an inner ring of larger protrusions with a larger footprint or base area.

FIGS. 10 to 12 show a system scaffold leg 30 and head 29 with an adapter 10 and a shock absorbing insert 27. The scaffolding leg tube 30 illustrated is shown in its use as a vertical standard has an external diameter of 48.3 mm. Using the adapter allows a base/head 29 to be fitted on top to connect to the safety decking system. As shown, adapter is oriented with the second shaped adapter part 12 uppermost and a shock absorbing insert 27 engaged with the end of the annular wall 21. The shock absorbing insert 27 acts to spread load and dampen force. The end of the scaffold leg 30 is inserted into the first bore portion 13 in the first shaped adapter part 11 with the end edge of the scaffold leg 30 abutting the abutment shoulder 15.

FIGS. 13 to 15 show use of the adapter 10 with a scaffolding base jack to sit on top of the base jack allowing a safety decking leg profile to be fitted on top. A base jack may allow the height of the system to be increased by up to 500 mm, offering flexibility in heights required. As shown, adapter 10 is oriented with the first shaped adapter part 11 uppermost. An internally threaded jack spindle 33 is engaged with the externally threaded base jack member 32 and the adapter 10 is then placed over the end of the threaded base jack member 32 so that the threaded base jack member 32 extends through the second bore portion 14 and the first bore portion 13. The adapter 10 is then directly supported on an upper surface of the internally threaded jack spindle 33 and can allow a safety decking leg profile 31 to be fitted on top, receiving the first shaped adapter part 11 into a hollow end thereof.

FIGS. 16 to 19 show the adapter 10 used with a system scaffolding standard with spigot 34 in its use as a vertical standard, the spigot having a diameter of 36 mm. The use of the adapter 10 allows a base/head 29 to be fitted on top of the spigot to connect to the safety decking system.

As shown, adapter 10 is oriented with the second shaped adapter part 12 uppermost. The adapter 10 is placed over the end of the spigot 34 and a shock absorbing insert 27 engaged with the end of the annular wall 21. The head 29 is supported by the shock absorbing insert 27 and receives the second shaped adapter part 12.

The one or more embodiments are described above by way of example only. Many variations are possible without departing from the scope of protection afforded by the appended claims.

1. A scaffold or safety decking leg adapter comprising:
a) a first shaped adapter part at a first end and with a first exterior dimension;
b) a second shaped adapter part at a second end opposite to the first end and with a second exterior dimension different to the first exterior dimension;
c) a first bore portion through the first shaped adapter part and with a first interior dimension;
d) a second bore portion through the second shaped adapter part, in communication with the first bore portion and with a second interior dimension different to the first interior dimension; and
e) an abutment shoulder between the first bore portion and the second bore portion.

2. The scaffold or safety decking leg adapter as claimed in claim 1, wherein the first shaped adapter part has a rectangular outer shape.

3. The scaffold or safety decking leg adapter as claimed in claim 1, wherein the first shaped adapter part has a circular inner first bore portion extending longitudinally into the first shaped adapter part.

4. The scaffold or safety decking leg adapter as claimed in claim 1, wherein an outer shape of the first shaped adapter part is formed by respective external surfaces of a plurality of ribs.

5. (canceled)

6. The scaffold or safety decking leg adapter as claimed in claim 4, wherein the ribs are formed on/extend from an outer cylindrical surface of an annular wall and an inner surface of the annular wall defines the first bore portion.

7. The scaffold or safety decking leg adapter as claimed in 1, wherein the second shaped adapter part has a rectangular outer shape.

8. The scaffold or safety decking leg adapter as claimed in claim 7, wherein the outer shape of the second shaped adapter part is formed by respective external surfaces of a plurality of ribs.

9. (canceled)

10. The scaffold or safety decking leg adapter as claimed in claim 1, wherein the second shaped adapter part includes a rectangular wall defining a hollow volume within it.

11. The scaffold or safety decking leg adapter as claimed in claim 10, wherein an annular wall or upstand is provided within the hollow volume.

12. (canceled)

13. The scaffold or safety decking leg adapter as claimed in claim 11, wherein an inner surface of the annular wall or upstand defines the second bore portion.

14. The scaffold or safety decking leg adapter as claimed in claim 11, wherein an outer surface of the annular wall or upstand is spaced from an inner surface of the rectangular wall.

15-16. (canceled)

17. The scaffold or safety decking leg adapter as claimed in claim 1, wherein the second exterior dimension of the second shaped adapter part is larger than the first exterior dimension of the first shaped adapter part.

18. The scaffold or safety decking leg adapter as claimed in claim 1, wherein the first bore portion is circular in cross-sectional shape, extending from a free end of the first shaped adapter part toward the second shaped adapter part.

19. (canceled)

20. The scaffold or safety decking leg adapter as claimed in claim 1, wherein the first bore portion has a larger internal diameter than the second bore portion.

21. The scaffold or safety decking leg adapter as claimed in claim 1, wherein the first bore portion is coaxial with the second bore portion.

22. The scaffold or safety decking leg adapter as claimed in claim 1, wherein the second bore portion is circular in cross-sectional shape, extending from a free end of the second shaped adapter part toward the first shaped adapter part.

23. (canceled)

24. The scaffold or safety decking leg adapter as claimed in claim 1, wherein the abutment shoulder extends perpendicularly between an inner surface of the first bore portion and an inner surface of the second bore portion.

25. The scaffold or safety decking leg adapter as claimed in claim 1, further comprising a lateral flange extend radially outwardly from the first shaped adapter part and/or the second shaped adapter part.

26. The scaffold or safety decking leg adapter as claimed in claim 1, further comprising a resilient and/or deformable shock absorbing member.
